(19) United States
(12) Patent Application Publication
(10) Pub. No.: US 2026/0164299 A1
(43) Pub. Date: Jun. 11, 2026

(54) Buffer Size Optimization in XR

(71) Applicant: Apple Inc., Cupertino, CA (US)

(72) Inventors: Murali NARASIMHA, Livermore, CA (US); Ralf ROSSBACH, Munich (DE); Ping-Heng KUO, London (GB)

(21) Appl. No.: 19/124,095

(22) PCT Filed: Oct. 27, 2023
(86) PCT No.: PCT/US2023/036075

§ 371 Date: Apr. 24, 2025

Related U.S. Application Data
(60) Provisional application No. 63/381,625, filed on Oct. 31, 2022.

(51) Int. Cl. H04W 28/02; H04W 76/20

(52) U.S. Cl. CPC H04W 28/0278; H04W 28/0268; H04W 76/20

(57) ABSTRACT

A user equipment (UE) configured to determine a characteristic of a traffic pattern of the UE, transmit, to a network, a buffer status report (BSR) negotiation message comprising information related to buffer size indices to be reported in BSR to the network, wherein the BSR negotiation message is based on the characteristic, decode, based on signals received from the network, a BSR negotiation message response comprising an indication of a first mapping between the buffer size indices and buffer sizes and transmit BSR to the network based on the BSR negotiation message response.

### PRIORITY/INCORPORATION BY REFERENCE

This application claims priority to U.S. Provisional Application 63/381,625 filed on Oct. 31, 2022, and entitled, “Buffer Size Optimization in XR,” the entirety of which is incorporated herein by reference.

### BACKGROUND

Augmented Reality (AR) and Virtual Reality (VR) (henceforth Extended Reality (XR)) have traffic patterns that consist of periodic data transmission. Unlike voice traffic, XR data bursts may vary in size. Additionally, XR has high reliability and low latency requirements to ensure a convincing and high-quality user experience.

In cellular networks (e.g., 4G/5G), the network allocates uplink (UL) transmission resources (i.e., UL grants) to a user equipment (UE) in response to a buffer status report (BSR). The BSR includes a buffer size, which provides an estimate of the amount of buffered UL data at the UE to be transmitted to the network. The BSR is transmitted as a medium access control (MAC) control element (CE) via a physical uplink shared channel (PUSCH). The UL resources for transmitting the PUSCH containing the BSR are typically provided by the network in response to a scheduling request (SR) or may be available as a configured grant (CG).

Buffer sizes reported by the UE are standardized under 3GPP TS 38.321. Typically, buffer size is indicated in the BSR. Under this regime, the buffer size is quantized using a small number of bits (5 or 8 bits) per logical channel group. This quantization minimizes overhead of buffer status reporting. Accordingly, a variety of different buffer sizes can be bucketized into 2⁸=256 values (assuming an 8 bit BSR). A UE reports its buffer size as an index representing one of the buckets. The network then assumes that the amount of data buffered at the UE is the upper limit of a bucket and allocates uplink resources until the buffer of the UE is emptied.

An example of the above is clarifying. A UE may have a buffer data of 174,000 bits; it reports a BS index of 156, which indicates a buffer status value between 171,232 and 182,345 bits. The network allocates uplink resources for transmission of 182,345 (the upper boundary of the bucket) bits, which is greater than the 174,000 buffered bits. The UE then transmits (182,435-174,000) 8,345 padding bits appended to the end of the buffered UL data.

This overallocation leads to system wide inefficiencies for XR traffic, particularly in locations with poor UL coverage.

### SUMMARY

Some example embodiments are related to an apparatus of a user equipment (UE), the apparatus including processing circuitry configured to determine a characteristic of a traffic pattern of the UE, configure transceiver circuitry to transmit, to a network, a buffer status report (BSR) negotiation message comprising information related to buffer size indices to be reported in BSR to the network, wherein the BSR negotiation message is based on the characteristic, decode, based on signals received from the network, a BSR negotiation message response comprising an indication of a first mapping between the buffer size indices and buffer sizes, and configure transceiver circuitry to transmit BSR to the network based on the BSR negotiation message response.

Other example embodiments are related to an apparatus of a base station, the apparatus including processing circuitry configured to decode, based on signals received from a user equipment (UE), a buffer status report (BSR) negotiation message comprising information related to buffer size indices to be reported in BSR to the base station, configure transceiver circuitry to transmit, to the UE, a BSR negotiation message response comprising an indication of a first mapping between the buffer size indices and buffer sizes and decode, based on signals received from the UE, BSR based on the BSR negotiation message response.

Still further example embodiments are related to an apparatus of a base station, the apparatus including processing circuitry configured to determine a characteristic of a traffic pattern of a user equipment (UE), configure transceiver circuitry to transmit, to the UE, a buffer status report (BSR) negotiation message comprising information related to buffer size indices to be reported in BSR to the network, wherein the BSR negotiation message is based on the characteristic, decode, based on signals received from the UE, a BSR negotiation message response comprising an indication of a first mapping between the buffer size indices and buffer sizes, decode, based on signals received from the UE, BSR based on the BSR negotiation message response.

Additional example embodiments are related to an apparatus of a user equipment (UE), the apparatus including processing circuitry configured to determine a buffer size of the UE, wherein the buffer size indicates an amount of data in a buffer of the UE, determine a buffer size index corresponding to the buffer size based on a pre-determined mapping between buffer size indices and buffer sizes, determine a condition related to the buffer size and the pre-determined mapping is satisfied, wherein the condition being satisfied indicates a delta BSR indication is to be sent to a network and configure transceiver circuitry to transmit, to the network, a buffer status report (BSR) comprising the buffer size index and the delta BSR indication.

Further example embodiments are related to an apparatus of a base station, the apparatus including processing circuitry configured to decode, based on signals received from a user equipment (UE), a buffer status report (BSR) comprising a buffer size index and the delta BSR indication, wherein the buffer size index corresponds to a maximum value of a buffer size of the UE and configure transceiver circuitry to transmit, to the UE, one or more grants corresponding to the buffer size index, wherein the one or more grants comprise less than the maximum value.

### BRIEF DESCRIPTION OF THE DRAWINGS

FIG. 1 shows an example network arrangement according to various example embodiments.

FIG. 2 shows an example UE according to various example embodiments.

FIG. 3 shows an example base station according to various example embodiments.

FIG. 4 shows an example 256-bit buffer size mapping table according to various example embodiments.

FIG. 5 shows a buffer size mapping switch MAC-CE according to various example embodiments.

FIG. 6 shows a call flow for improved UE to network buffer status reporting operations according to various example embodiments.

FIG. 7 shows a call flow for improved network to UE buffer status reporting according to various example embodiments.

### DETAILED DESCRIPTION

The example embodiments may be further understood with reference to the following description and the related appended drawings, wherein like elements are provided with the same reference numerals. The example embodiments relate to enhanced buffer size reporting for XR use cases.

It should be understood that while the present disclosure is described with reference to XR traffic, the example embodiments are not limited to XR use cases. Specifically, the enhanced buffer size reporting of the example embodiments may be used for any type of UE traffic and is not limited to XR traffic.

The example embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any electronic component.

The example embodiments are also described with reference to a 5G New Radio (NR) network. However, it should be understood that the example embodiments may also be implemented in other types of networks, including but not limited to LTE networks, future evolutions of the cellular protocol, or any other type of network.

UL transmission at a UE is scheduled using a physical downlink control channel (PDCCH). The PDCCH indicates the resource allocation and the modulation and coding scheme (MCS) to be used. If the resources allocated by the network are greater than what is needed to transmit the data buffered at the UE using the indicated MCS, the UE places padding bits (typically 0s) at the end of the transmission. These padding bits are a waste of resources, and it is beneficial to minimize their occurrence.

It is possible that future iterations of 3GPP standards feature Buffer Size Levels tables that are defined specifically for XR. A network may offer support for multiple Buffer Size Levels tables. Using these pre-defined tables, a UE need not signal a constructed table. It is also possible that the UE may indicate in a UE capability message which Buffer Size Levels table(s) that it supports.

During initial access, a UE may utilize a default Buffer Size Levels table. Once the UE is operating in an RRC connected mode (or when an XR session begins), the network may switch to a different Buffer Size Levels table via an RRC reconfiguration message at the beginning of the XR session, and switch back at the end of the XR session (via another RRC reconfiguration message or during RRC release). The same switching may also occur by use of a separate RRC or MAC procedure with a request followed by an accept or confirmation (at either the UE or the network).

Alternatively, if different services are associated with different 5G Quality of Service (QoS) Identifier (5QIs) or QoS Flow ID (QFIs), the 3GPP standard may associate multiple Buffer Size Levels tables in a number of ways.

One such association entails different tables being linked in a fixed manner to dedicated 5QIs/QFIs (or services). Multiple 5QI/QFIs may be mapped to the same Buffer Size Levels table as well (via Non-Access Stratum (NAS) or RRC). When the UE or the network initiates a session over this 5QI/QFI, the associated Buffer Size Levels table is used by default. In the case that the UE has multiple services active at the same time, the network may allocate a Buffer Size Levels table with a number, or there may be a priority logic to select between multiple tables.

Another table association scheme may entail a UE indicating to the network via a UE capability message which table(s) that the UE supports, and the network then enables one or more of the supported tables via an RRC message.

Alternatively, a UE may indicate a capability for a different quantization of a Buffer Size Levels table such that the Buffer Size Levels table defined in the standard does not need to be altered, but interpretation table indices may be changed by adding a weight factor to the values in the table. The weight factor may change in non-linear fashion for different entries in the table. The UE and the network may then agree on a weight factor.

To minimize the overhead signaling of a buffer size mapping request, the UE may transmit (i) a lowest possible buffer size, (ii) a highest possible buffer size, and (iii) a step size to the network. The network may then use these values to construct a buffer size table. The network may also configure multiple buffer size mappings. In an example, different bearers or 5QI values may use different buffer size mappings. The UE may indicate a buffer size mapping configuration index in the BSR. The base station is then informed which mapping the UE is using for this particular buffer status report.

The buffer size mapping may also be linked to logical channel groups (LCG) and/or logical channels (LCHs). The network may first provide a mapping relationship between each LCG/LCH and a buffer size mapping. The buffer size mapping info may be provided by the UE or may be pre-configured based on the type of bearer established. In this case, the network may know which buffer size table the UE is using by reference to the LCG index or LCH index in the BSR. Note that different buffer size tables may correspond to different BSR formats, and the UE can select the BSR size table and/or BSR format based on which LCG/LCH has data available in the buffer. If two or more LCGs/LCHs mapping to different buffer size tables and/or BSR formats have data available, the UE may select the buffer size table and/or BSR format based on the characteristics of the two or more LCGs/LCHs, such as LCH priority, and/or delay status of buffered data.

One of skill in the art will recognize that the existing padding scheme is a significant waste of resources for XR devices. For voice traffic (typical of XR use cases), the volume of data is typically small and fixed (and it is often managed using periodic pre-allocated resources, e.g., configured grants). For conventional traffic such as file transfer protocol (FTP), the data bursts are longer and the occurrence of padding bits at the end of a data burst does not significantly impact efficiency.

In a first aspect of the example embodiments, a scheme wherein a UE negotiates with the network a mapping of BS index values to buffer sizes is disclosed. In a second aspect of the example embodiments, a delta buffer size indication is disclosed to allow the UE and the network to understand the buffer size of the UE based on an existing buffer size levels table.

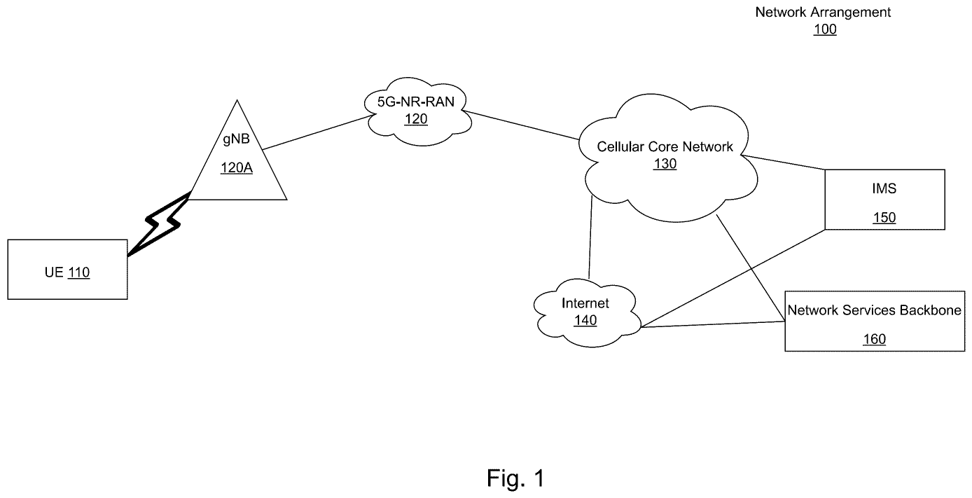

FIG. 1 shows an example network arrangement 100 according to various example embodiments. The example network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

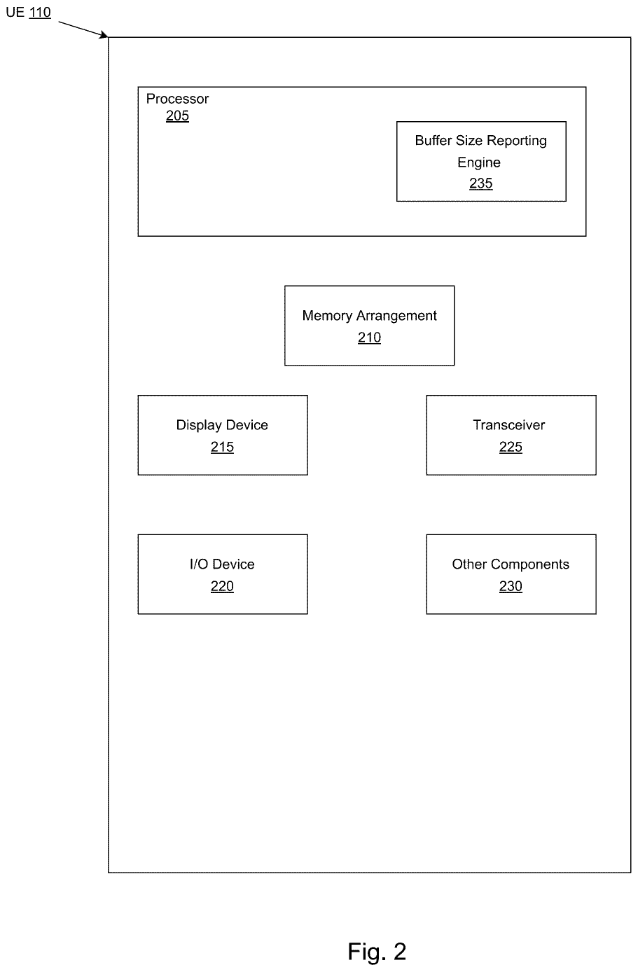

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a buffer size reporting engine 235 for performing operations such as determining a characteristic of data traffic of the UE, selecting an appropriate buffer size mapping table, and negotiating the buffer size reporting scheme with the network.

The above referenced engine being an application (e.g., a program) executed by the processor 205 is only an example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

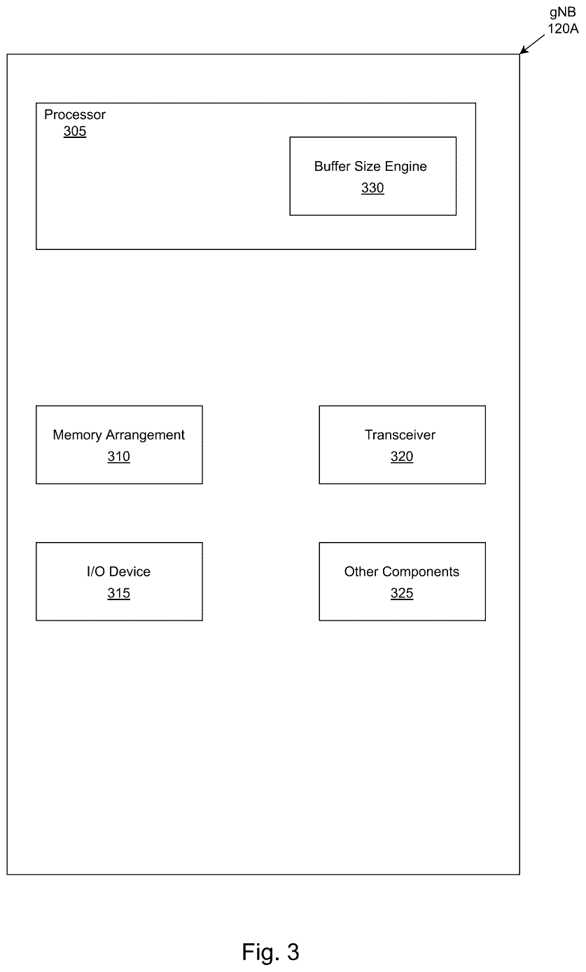

FIG. 3 shows an example base station 300 according to various example embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a buffer size engine 330 for performing operations such as negotiating the buffer size reporting scheme with the UE.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100.

The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

XR traffic typically consists of multiple streams of audio and video. Each stream may have a different periodicity. The packets in each stream, although periodic, may be of different sizes. Thus, the amount of data produced at the XR device at periodic intervals is not fixed. It should be noted however, that the amount of data produced may be one of a few possible sizes, due to the overlap of periodicities of the different streams that have been setup. To minimize the occurrence of padding bits, a buffer size table for XR may be based on the possible buffer sizes that can occur for a given transmission.

In a first aspect of the example embodiments, a UE negotiates with the network with respect to a mapping of BS index values to buffer sizes. Specifically, the UE indicates that the UE will not be using the standardized mapping from 3GPP TS 38.321 but rather a different mapping that is more appropriate for the type of traffic that the UE expects to exchange with the network. As described above, the UE may have knowledge of the expected traffic pattern for data associated with the application that the UE is executing. Thus, the UE may determine buffer status indices that are more appropriate for the traffic patter, e.g., that require less padding than the standardized buffer sizes.

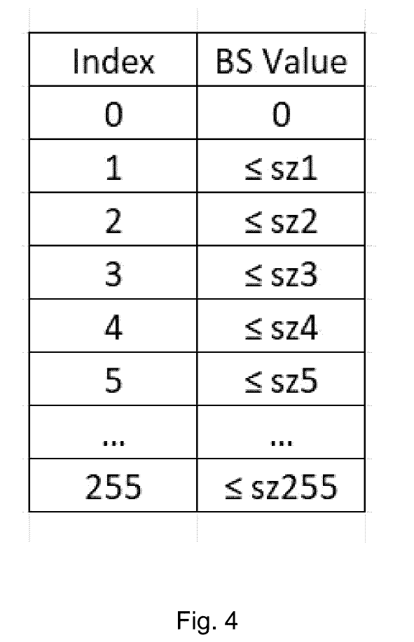

FIG. 4 shows an example 256-bit buffer size mapping table according to various example embodiments. At the time of session establishment, the UE determines possible buffer sizes for a given radio bearer (shown in FIG. 4 as sz1, sz2 . . . ). The UE transmits a buffer size mapping request message to the network indicating that buffer size index n should be mapped to szn. This mapping continues to buffer size index 255, which exhausts the 8-bit value space when using 0 as the ordinal first index (2\hat{ }=256 ). The network may then send a buffer size mapping accept message to the UE.

When the UE sends a BSR with a buffer size index from the new buffer size mapping, the network may perform resource allocation according to the new mapping. The buffer size mapping request may be transmitted by a radio resource control (RRC) message or via a medium access control-control element (MAC-CE). Additionally, it should be understood that a switching mechanism may be utilized to move from the original (standardized) buffer size table (e.g., as specified in 3GPP TS 38.321) to the UE-determined buffer size table (e.g., FIG. 4).

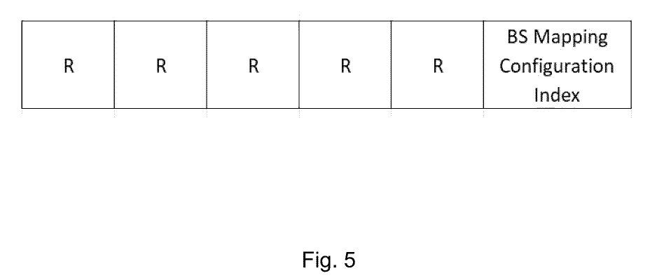

FIG. 5 shows a buffer size mapping switch MAC-CE according to various example embodiments. This mapping switch may be understood to switch the UE from a standard mapping to a UE-determined mapping or to a pre-determined mapping. The UE may transmit the buffer size mapping switch MAC-CE to the network to indicate the buffer size mapping that the UE has chosen. The MAC-CE may indicate a BS mapping configuration index to indicate one of multiple previously negotiated buffer size mappings. For example, a BS mapping configuration index of “000” may indicate that the UE is switching to the original (non-negotiated) buffer size mapping. The buffer size mapping switch MAC-CE may have its own logical channel ID. It should also be understood that the buffer size mapping switch may also operate to switch the UE from a default/pre-determined mapping to a UE-determined mapping scheme.

There may be variations on the basic buffer size negotiation scheme. One of skill in the art will recognize that the buffer size mapping switch may be performed as an RRC procedure with separate RRC messages for both the buffer size request from the UE and the accept message from the network. The procedure may also be performed over MAC, with the UE transmitting in UL a MAC-CE for the request and receiving in DL from the network a MAC-CE for confirmation.

In other example embodiments, buffer size mapping negotiation may also be initiated by the network, and the UE may instead send the acknowledgement. This variation may be desirable when a switch to a different mapping table is required by either the UE or by the network.

In still further example embodiments, the buffer size mapping negotiation may utilize both a UE capability and a network configuration with an RRC parameter. The network may then enable the parameter (or a specific Buffer Size Levels table with an index) at the beginning of the XR session and disable it at the end of the session. This enabling/disabling scheme may also be performed in an RRC reconfiguration message.

In additional example embodiments, the UE may indicate to the network a preference for a specific Buffer Size Levels table via UE assistance information, and the network may enable the indicated table with a parameter update in an RRC reconfiguration.

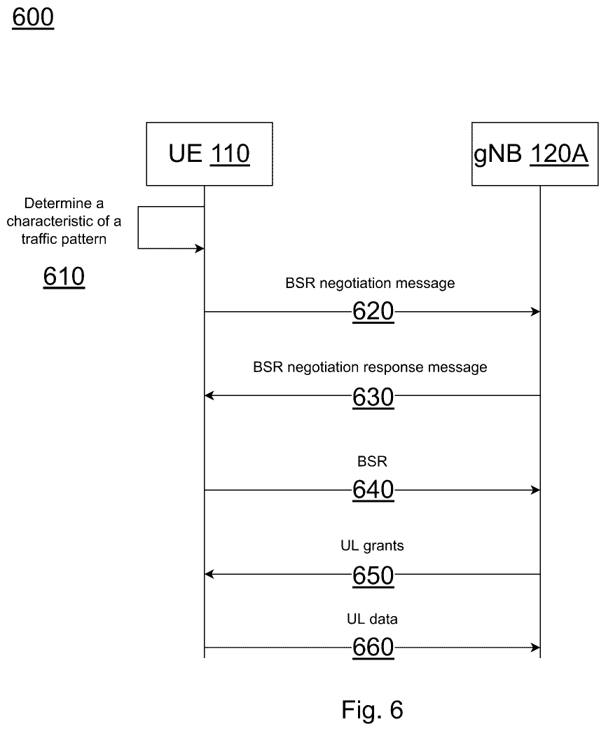

FIG. 6 shows a call flow 600 for improved UE to network buffer status reporting operations according to various example embodiments. It should be understood that call flow diagram 600 is described with respect to the first aspect of the example embodiments.

In 610, the UE 110 determines a characteristic of a traffic pattern of the UE 110. In an example, this characteristic may be responsive to a service or application on the UE 110 (e.g., 5Qis, QFIs, etc.). The UE 110 may generate a buffer size mapping table such as the table shown in FIG. 4 based on this characteristic.

Alternatively, the UE 110 may determine that a specific predetermined buffer size mapping should be used. As described above, based on the knowledge the UE 110 has regarding likely traffic patterns for the application being executed by the UE 110, the UE 110 may generate or select a buffer size mapping table that minimizes the transmission of padding data.

In 620, the UE 110 transmits a BSR negotiation message to the gNB 120A. The BSR negotiation message 620 may be understood to comprise a custom buffer size mapping (e.g., FIG. 4), or it may comprise a buffer size mapping switch (e.g., FIG. 5) or a combination of the above.

The gNB 120A then transmits a BSR negotiation response message 630 to the UE 110. This message 630 indicates to the UE 110 whether the network will proceed with the proposed mapping scheme from the BSR negotiation message 620. Call flow diagram proceeds with BSR negotiation response message being an affirmative reply. One of skill in the art will understand that a standard buffer size mapping table may be used by the UE 110 and the gNB 120A if the BSR negotiation response message is a negative reply (i.e., the network has denied the UE 110 request for a different buffer size mapping table).

In 640, the UE 110 transmits buffer status reports to the gNB 120A having buffer status indices based on the selected BSR mapping. In 650, the gNB 120A transmits uplink grants to the UE 110 based on the buffer status index in the buffer status report. In 660, the UE 110 begins transmission of the buffered UL data. Ideally, UL transmission 660 will contain fewer padding bits than if the UE 110 had utilized a standard buffer size mapping table. Elimination of padding bits allows for UE UL transmission to terminate sooner, thereby offering gains in power efficiency and transmission speed.

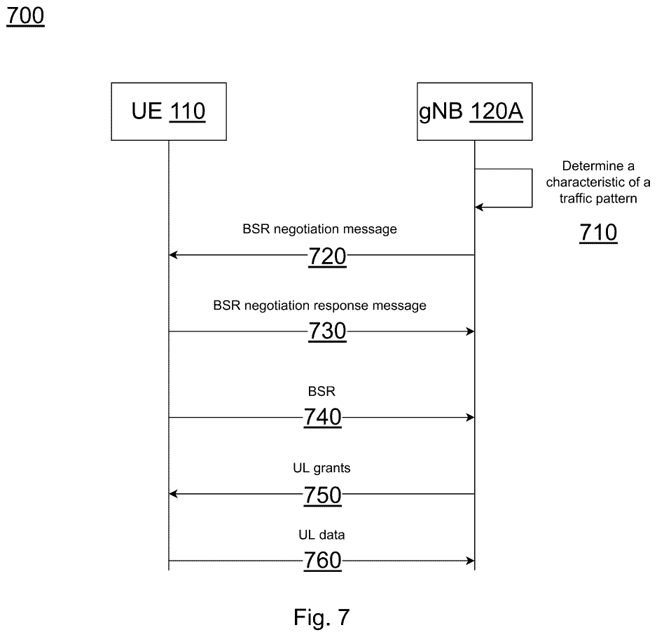

As mentioned above, the network may also initiate the first aspect of the example embodiments. FIG. 7 shows a call flow 700 for improved network to UE buffer status reporting according to various example embodiments. Call flow 700 is substantially similar to call flow 600. Of note in this figure is that gNB 120A determines the characteristic of a traffic pattern of the UE 110. In an example, this characteristic may be responsive to a service or application on the UE 110 (e.g., 5Qis, QFIs, etc.). The gNB 120A may generate a buffer size mapping table such as the table shown in FIG. 4 based on this characteristic.

In 720, the gNB 120A transmits a BSR negotiation message based on the characteristic determined in 710. The BSR negotiation message may include a gNB-determined buffer sized mapping proposal, or it may include an indication to use a pre-determined table, or a buffer size mapping switch as described in FIG. 5, or a combination of the above.

In 730, the UE 110 sends a BSR negotiation response message. This message 730 indicates to the gNB 120A whether the UE 110 will proceed with the proposed mapping scheme from the BSR negotiation message 720. Call flow diagram 700 proceeds with BSR negotiation response message being an affirmative reply. One of skill in the art will understand that a standard buffer size mapping table may be used by the UE 110 and the gNB 120A if the BSR negotiation response message is a negative reply (i.e., the UE 110 has denied the gNB 120A request for a different buffer size mapping table). Operations 740-760 proceed identically as described with respect to operations 640-660.

In a second aspect of the example embodiments, a delta buffer size indication is disclosed. In XR devices, the UE may transmit a delta BSR. A delta BSR may be understood as an indication of a reduction of buffer size relative to the last BSR transmitted by the UE to the network. The delta BSR may be transmitted after a first BSR (optionally in the same PUSCH).

A delta BSR may enable the network to allocate uplink resources more accurately while relying on existing buffer status reporting mechanisms. A delta BSR may be an addition to the BSR framework that networks may implement and configure as needed. Transmission of a delta BSR may be triggered by fulfillment of conditions such that the delta BSR is not excessively transmitted. For example, the delta BSR could be transmitted only if the difference between the reported buffer size and the actual buffer size is more than a threshold. For example, after reporting a BS index of 128, the UE may trigger a delta BSR if the BS value corresponding to index 128—BS value corresponding to index 127 is at least twice the actual buffer size—BS value corresponding to index 127.

A delta BSR may also be used to indicate a reduction of buffer size due to dropping of certain packets. For latency sensitive traffic, if some of the packets to be transmitted are delayed significantly (e.g., due to time duration before resource availability for BSR transmission), it may be beneficial to discard packets as they will not be used at the peer entity. In such cases, the discard of packets may occur after the BSR has been transmitted or after the BSR has been prepared for transmission. The delta BSR may indicate the reduction in buffer size due to such packet discard, enabling the network to correspondingly lower its resource allocation.

### EXAMPLES

In a first example, a method performed by a user equipment (UE), comprising determining a characteristic of a traffic pattern of the UE, transmitting, to a network, a buffer status report (BSR) negotiation message comprising information related to buffer size indices to be reported in BSR to the network, wherein the BSR negotiation message is based on the characteristic, receiving a BSR negotiation message response from the network comprising an indication of a first mapping between the buffer size indices and buffer sizes, transmitting BSR to the network based on the BSR negotiation message response.

In a second example, the method of the first example, wherein the characteristic comprises (i)a 5G Quality of Service (QoS) Identifier (5QIs), (ii) a QoS flow ID (QFI), or (iii) a service at the UE.

In a third example, the method of the first example, wherein the BSR negotiation message and the BSR negotiation message response are exchanged via a medium access control (MAC) or a radio resource control (RRC) message.

In a fourth example, the method of the first example, wherein the information comprises the first mapping of the buffer size indices to buffer size values.

In a fifth example, the method of the first example, wherein the information comprises an indication identifying a pre-determined buffer size mapping.

In a sixth example, the method of the first example, wherein the information comprises a pre-determined buffer size mapping.

In a seventh example, the method of the first example, wherein the information comprises a weight factor to be applied to a pre-determined buffer size mapping.

In an eighth example, the method of the first example, wherein the information comprises a lowest possible buffer size, a highest possible buffer size, and a step size.

In a ninth example, the method of the first example, further comprising transmitting a message to the network indicating a switch from the first mapping to a second mapping.

In a tenth example, the method of the ninth example, further comprising transmitting a second message to the network indicating a further switch from the second mapping to the first mapping.

In an eleventh example, the method of the ninth example, wherein the message is transmitted via a medium access control (MAC) or a radio resource control (RRC) message.

In a twelfth example, the method of the first example, wherein the BSR negotiation message further comprises a UE capability with respect to mappings between the buffer size indices and buffer sizes.

In a thirteenth example, the method of the first example, wherein the BSR negotiation message is transmitted via UE assistance information.

In a fourteenth example, the method of the thirteenth example, wherein the BSR negotiation message response comprises an RRC message, the RRC message comprising a parameter update.

In a fifteenth example, a processor configured to perform any of the methods of the first through fourteenth examples.

In a sixteenth example, a user equipment (UE) comprising a transceiver configured to communicate with a base station and a processor communicatively coupled to the transceiver and configured to perform any of the methods of the first through fourteenth examples.

In a seventeenth example, a method performed by a base station, comprising receiving, from a user equipment (UE), a buffer status report (BSR) negotiation message comprising information related to buffer size indices to be reported in BSR to the base station, transmitting, to the UE, a BSR negotiation message response comprising an indication of a first mapping between the buffer size indices and buffer sizes, and receiving, from the UE, BSR based on the BSR negotiation message response.

In an eighteenth example, the method of the seventeenth example, wherein the BSR negotiation message and the BSR negotiation message response are exchanged via a medium access control (MAC) or a radio resource control (RRC) message.

In a nineteenth example, the method of the seventeenth example, wherein the information comprises the first mapping of the buffer size indices to buffer size values.

In a twentieth example, the method of the seventeenth example, wherein the information comprises an indication identifying a pre-determined buffer size mapping.

In a twenty first example, the method of the seventeenth example, wherein the information comprises a pre-determined buffer size mapping.

In a twenty second example, the method of the seventeenth example, wherein the information comprises a weight factor to be applied to a pre-determined buffer size mapping.

In a twenty third example, the method of the seventeenth example, wherein the information comprises a lowest possible buffer size, a highest possible buffer size, and a step size.

In a twenty fourth example, the method of the seventeenth example, further comprising receiving, from the UE, a message indicating a switch from the first mapping to a second mapping.

In a twenty fifth example, the method of the twenty fourth example, further comprising receiving, from the UE, a second message indicating a further switch from the second mapping to the first mapping.

In a twenty sixth example, the method of the twenty fourth example, wherein the message is received via a medium access control (MAC) or a radio resource control (RRC) message.

In a twenty seventh example, the method of the seventeenth example, wherein the BSR negotiation message further comprises a UE capability with respect to mappings between the buffer size indices and buffer sizes.

In a twenty eighth example, the method of the seventeenth example, wherein the BSR negotiation message is transmitted via UE assistance information.

In a twenty ninth example, the method of the seventeenth example, wherein the BSR negotiation message response comprises an RRC message, the RRC message comprising a parameter update.

In a thirtieth example, a processor configured to perform any of the methods of the seventeenth through twenty ninth examples.

In a thirty first example, a base station comprising a transceiver configured to communicate with a user equipment (UE) and a processor communicatively coupled to the transceiver and configured to perform any of the methods of the seventeenth through twenty ninth examples.

In a thirty second example, a method performed by a base station, comprising determining a characteristic of a traffic pattern of a user equipment (UE), transmitting, to the UE, a buffer status report (BSR) negotiation message comprising information related to buffer size indices to be reported in BSR to the network, wherein the BSR negotiation message is based on the characteristic, receiving a BSR negotiation message response from the UE comprising an indication of a first mapping between the buffer size indices and buffer sizes, receiving, from the UE, BSR based on the BSR negotiation message response.

In a thirty third example, the method of the thirty second example, wherein the characteristic comprises (i)a 5G Quality of Service (QoS) Identifier (5QIs), (ii) a QoS flow ID (QFI), or (iii) a service at the UE.

In a thirty fourth example, the method of the thirty second example, wherein the BSR negotiation message and the BSR negotiation message response are exchanged via a medium access control (MAC) or a radio resource control (RRC) message.

In a thirty fifth example, the method of the thirty second example, wherein the information comprises the first mapping of the buffer size indices to buffer size values.

In a thirty sixth example, the method of the thirty second example, wherein the information comprises an indication identifying a pre-determined buffer size mapping.

In a thirty seventh example, the method of the thirty second example, wherein the information comprises a pre-determined buffer size mapping.

In a thirty eighth example, the method of the thirty second example, further comprising transmitting a message to the UE indicating a switch from the first mapping to a second mapping.

In a thirty ninth example, the method of the thirty eighth example, further comprising transmitting a second message to the UE indicating a further switch from the second mapping to the first mapping.

In a fortieth example, the method of the thirty eighth example, wherein the message is transmitted via a medium access control (MAC) or a radio resource control (RRC) message.

In a forty first example, a processor configured to perform any of the methods of the thirty second through fortieth examples.

In a forty second example, a base station comprising a transceiver configured to communicate with a user equipment (UE) and a processor communicatively coupled to the transceiver and configured to perform any of the methods of the thirty second through fortieth examples.

In a forty third example, a method performed by a user equipment (UE), comprising determining a buffer size of the UE, wherein the buffer size indicates an amount of data in a buffer of the UE, determining a buffer size index corresponding to the buffer size based on a pre-determined mapping between buffer size indices and buffer sizes, determining a condition related to the buffer size and the pre-determined mapping is satisfied, wherein the condition being satisfied indicates a delta BSR indication is to be sent to a network, and transmitting, to the network, a buffer status report (BSR) comprising the buffer size index and the delta BSR indication.

In a forty fourth example, the method of the forty third example, wherein the condition comprises a maximum value of a buffer size corresponding to the buffer size index minus a maximum value of a buffer size corresponding to a next lower buffer size index from the buffer size index is greater, by a predetermined amount, than the buffer size minus the maximum value of the buffer size corresponding to the next lower buffer size index.

In a forty fifth example, a processor configured to perform any of the methods of the forty third through forty fourth examples.

In a forty sixth example, a user equipment (UE) comprising a transceiver configured to communicate with a base station and a processor communicatively coupled to the transceiver and configured to perform any of the methods of the forty third through forty fourth examples.

In a forty seventh example, a method performed by a base station (UE), comprising receiving, from a user equipment (UE), a buffer status report (BSR) comprising a buffer size index and the delta BSR indication, wherein the buffer size index corresponds to a maximum value of a buffer size of the UE and transmitting, to the UE, one or more grants corresponding to the buffer size index, wherein the one or more grants comprise less than the maximum value.

In a forty eighth example, a processor configured to perform the method of the forty seventh example.

In a forty ninth example, a base station comprising a transceiver configured to communicate with a user equipment (UE) and a processor communicatively coupled to the transceiver and configured to perform the method of the forty seventh example.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. In a further example, the example embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configured to:
determine a characteristic of a traffic pattern of the UE;
generate, for transmission to a network, a buffer status report (BSR) negotiation message comprising information related to buffer size indices to be reported in a BSR to the network, wherein the BSR negotiation message is based on the characteristic;
process, based on signaling received from the network, a BSR negotiation message response comprising an indication of a first mapping between the buffer size indices and buffer sizes; and
generate, for transmission to the network, the BSR based on the BSR negotiation message response.

2. The apparatus of claim 1, wherein the characteristic comprises (i)a 5G Quality of Service (QoS) Identifier (5QIs), (ii) a QoS flow ID (QFI), or (iii) a service at the UE.

3. The apparatus of claim 1, wherein the BSR negotiation message and the BSR negotiation message response are exchanged via a medium access control (MAC) or a radio resource control (RRC) message.

4. The apparatus of claim 1, wherein the information comprises the first mapping of the buffer size indices to buffer size values.

5. The apparatus of claim 1, wherein the information comprises an indication identifying a pre-determined buffer size mapping.

6. The apparatus of claim 1, wherein the information comprises a pre-determined buffer size mapping.

7. The apparatus of claim 1, wherein the information comprises a weight factor to be applied to a pre-determined buffer size mapping.

8. The apparatus of claim 1, wherein the information comprises a lowest possible buffer size, a highest possible buffer size, and a step size.

9. The apparatus of claim 1, wherein the processing circuitry is further configured to:
generate, for transmission to the network, a message indicating a switch from the first mapping to a second mapping; and
generate, for transmission to the network, a second message indicating a further switch from the second mapping to the first mapping.

10. The apparatus of claim 1, wherein the BSR negotiation message further comprises a UE capability with respect to mappings between the buffer size indices and buffer sizes.

11. The apparatus of claim 1, wherein the BSR negotiation message is transmitted via UE assistance information, wherein the BSR negotiation message response comprises an RRC message, the RRC message comprising a parameter update.

12. An apparatus of a base station, the apparatus comprising processing circuitry configured to:
process, based on signaling received from a user equipment (UE), a buffer status report (BSR) negotiation message comprising information related to buffer size indices to be reported in a BSR to the base station;
generate for transmission to the UE, a BSR negotiation message response comprising an indication of a first mapping between the buffer size indices and buffer sizes; and
process, based on signaling received from the UE, the BSR based on the BSR negotiation message response.

13. The apparatus of claim 12, wherein the BSR negotiation message and the BSR negotiation message response are exchanged via a medium access control (MAC) or a radio resource control (RRC) message.

14. The apparatus of claim 12, wherein the information comprises the first mapping of the buffer size indices to buffer size values.

15. The apparatus of claim 12, wherein the information comprises an indication identifying a pre-determined buffer size mapping.

16. The apparatus of claim 12, wherein the information comprises a pre-determined buffer size mapping.

17. The apparatus of claim 12, wherein the information comprises a weight factor to be applied to a pre-determined buffer size mapping.

18. The apparatus of claim 12, wherein the information comprises a lowest possible buffer size, a highest possible buffer size, and a step size.

19. The apparatus of claim 12, wherein the BSR negotiation message further comprises a UE capability with respect to mappings between the buffer size indices and buffer sizes.

20. An apparatus of a base station, the apparatus comprising processing circuitry configured to:
determine a characteristic of a traffic pattern of a user equipment (UE);
generate for transmission to the UE, a buffer status report (BSR) negotiation message comprising information related to buffer size indices to be reported in a BSR to the base station, wherein the BSR negotiation message is based on the characteristic;
process, based on signaling received from the UE, a BSR negotiation message response comprising an indication of a first mapping between the buffer size indices and buffer sizes; and
process, based on signaling received from the UE, the BSR based on the BSR negotiation message response.
